(19) United States
(12) Patent Application Publication
(10) Pub. No.: US 2020/0319757 A1
(43) Pub. Date: Oct. 8, 2020

(54) SYSTEM AND METHOD FOR CUSTOMIZED COMMEMORATIVE EVENT TICKET

(71) Applicant: Jeffrey T. Arnson, American Fork, UT (US)

(72) Inventor: Jeffrey T. Arnson, American Fork, UT (US)

(21) Appl. No.: 16/838,276

(22) Filed: Apr. 2, 2020

Related U.S. Application Data
(60) Provisional application No. 62/829,640, filed on Apr. 4, 2019.

(51) Int. Cl. G06F 3/0482; G06F 40/166; G06T 11/60

(52) U.S. Cl. CPC G06F 3/0482; G06T 2200/24; G06T 11/60; G06F 40/166

(57) ABSTRACT

A system and method for generative a commemorative event ticket is shown and described. The system may include a database server having a memory and one or more modules configured to send information to a user interface and receive input from the user interface. The memory may store information relating to an event, such as photographs taken during the event, statistical data relating to the event, etc. In some configurations the user may select the information they wish to be included on the commemorative event ticket.

### CROSS REFERENCE TO RELATED APPLICATION

A claim for the benefit of the Apr. 4, 2019 filing date of U.S. Provisional Patent Application 62/829,640, titled SYSTEM AND METHOD FOR CUSTOMIZED COMMEMORATIVE EVENT TICKET (“the '640 Provisional Application”) is hereby made pursuant to 35 U.S.C. § 119(e). The entire disclosure of the '640 Provisional Application is hereby incorporated herein.

### TECHNICAL FIELD

The present invention relates generally to a system and method for providing a customized event ticket. More specifically, the present invention relates to a system for storing, retrieving, and displaying information associated with an event to generate a customized event ticket.

### BACKGROUND

Typical spectator events which require a ticket, such as music concerts, sporting events, etc., are often attended by patrons who wish to keep a memento to remember the event. Many persons save their paper tickets, but these often only provide the bare details of the event such as the date, time, and seat assignment. Many events are moving to paperless ticketing on smartphones.

Spectator events are often associated with specific details, such as a sporting event that has a score and/or statistics for the game. Similarly, photographs from the specific event may be memorable. Thus it may be advantageous to provide a customized commemorative ticket for a user attending a spectator event.

### SUMMARY OF INVENTION

A system to generate a custom commemorative ticket may include a database server, a memory, one or more processors, and a user interface. In some configurations, the database server may be provided with one or more modules to receive input from a user interface and one or more modules to relay information to a user interface.

According to another aspect, the system may store data relating to the event, such as photographs taken during the event and statistical information relating to the event.

According to another aspect, photographs may be stored based on the event and also based on the location within the venue the photographs are taken. The user may input not only details relating to the event but also their seat assignments, and the system may retrieve photographs specific to the seat assignment inputted.

In some configurations, the user may be able to customize and select the photographs and data presented on the commemorative ticket. In other configurations, the system may generate the commemorative ticket based only on the initial input from the user relating to the event.

In some configurations, the user interface may be a user smartphone, a web browser, or a kiosk.

In accordance with one aspect of the disclosure, a method is provided to generate a commemorative ticket. The method may include inputting, by a user, the information relating to the event. In some configurations this may be accomplished by the user scanning their event ticket. In other configurations this may be manually entered by the user.

The method may further include retrieving data relating to the event and generating and printing the commemorative ticket.

According to an optional step, the method may further include allowing the user to upload their own photographs of the event to use on the commemorative ticket. The method may also include the step of allowing the user to select the information to display on the commemorative ticket.

### BRIEF DESCRIPTION OF DRAWINGS

The following drawings illustrate what are currently considered to be specific representative configurations for carrying out the invention and are not limiting as to embodiments which may be made in accordance with the present invention. The components in the drawings are not necessarily to scale relative to each other. Like reference numerals designate corresponding parts throughout the several views.

The drawings are illustrative and not limiting of the scope of the invention which is defined by the appended claims. The various elements of the invention accomplish various aspects and objects of the invention. Not every element of the invention can be clearly displayed in a single drawing, and as such not every drawing shows each element of the invention.

FIG. 1 is an overview block diagram illustrating an exemplary system for generating a commemorative event ticket.

FIG. 2 is a block diagram illustrating another exemplary configuration for generating a commemorative event ticket.

FIG. 3 is a flowchart illustrating an exemplary process, implemented in a network, used by an embodiment of the system to generate a commemorative event ticket.

### DETAILED DESCRIPTION

Many of the functional units described in this specification have been labeled as modules, or equivalent functional units, in order to more particularly emphasize their implementation independence. Modules are at least partially implemented in hardware, in one form or another. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented using software, stored on a physical storage device (e.g., a computer readable storage medium), for execution by various types of processors. Reference to a computer readable storage medium may take any physical form capable of storing machine-readable instructions, at least for a time in a non-transient state, on a digital processing apparatus. Examples of a computer readable storage medium include, but are not limited to, a semiconductor or solid state memory, magnetic tape, a removable computer diskette, a random access memory (RAM), a read-only memory (ROM), a Bernoulli drive, ARDUINO, a magnetic disk, flash memory, integrated circuits, or other digital processing apparatus memory device, and an optical disk. Current examples of optical disks include a compact disk with read only memory (CD-ROM), a compact disk with read/write (CD-R/W), and a digital video disk (DVD).

An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several storage or memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more physical devices which are referred to herein as computer readable media and/or electronic data storage devices.

In some embodiments, the software portions are stored in a non-transitory state such that the software portions, or representations thereof, persist in the same physical location for a period of time. Additionally, in some embodiments the software portions are stored on one or more non-transitory storage devices, which include hardware elements capable of storing non-transitory states and/or signals representative of the software portions, even though other portions of the non-transitory storage devices may be capable of altering and/or transmitting the signals. One example of a non-transitory storage device includes a read-only memory (ROM) which can store signals and/or states representative of the software portions for a period of time. However, the ability to store the signals and/or states is not diminished by further functionality of transmitting signals that are the same as or representative of the stored signals and/or states. For example, a processor may access the ROM to obtain signals that are representative of the stored signals and/or states in order to execute the corresponding software instructions.

Reference in the specification to “one configuration,” “one embodiment” “one aspect” or “a configuration,” “an embodiment” or “an aspect” means that a particular feature, structure, or characteristic described in connection with the configuration may be included in at least one configuration and not that any particular configuration is required to have a particular feature, structure or characteristic described herein unless set forth in the claim. The appearances of the phrase “in one configuration” or similar phrases in various places in the specification are not necessarily all referring to the same configuration, and may not necessarily limit the inclusion of a particular element of the invention to a single configuration, rather the element may be included in other or all configurations discussed herein. Thus it will be appreciated that the claims are not intended to be limited by the representative configurations shown herein. Rather, the various representative configurations are simply provided to help one of ordinary skill in the art to practice the inventive concepts claimed herein.

Furthermore, the described features, structures, or characteristics of embodiments of the invention may be combined in any suitable manner in one or more embodiments. In the following description, numerous specific details are provided, such as examples of programming, software modules (stored on a physical device), user selections, network transactions, database queries, database structures, hardware modules, hardware circuits, hardware chips, etc., to provide a thorough understanding of embodiments of the invention. One skilled in the relevant art will recognize, however, that embodiments of the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled operations are indicative of one embodiment of the presented method. Other operations and methods may be conceived that are equivalent in function, logic, or effect to one or more operations, or portions thereof, of the illustrated method. Additionally, the format and symbols employed are provided to explain the logical operations of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated operations of the depicted method. Additionally, the order in which a particular method occurs may or may not strictly adhere to the order of the corresponding operations shown.

Although the operations of the methods herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of various configurations. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a photograph” may include an embodiment having one or more of such photographs, and reference to “the processor” may include reference to one or more of such processors. “WiFi” means any type of wireless protocol. One with skill in the art will appreciate that any type of wireless protocol, such as Bluetooth, X10, RF, Zigbee, etc., could be used. Any mention of WiFi, etc., throughout this application should be construed broadly to encompass all types of wireless protocols known in the art.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The invention and accompanying drawings will now be discussed in reference to the numerals provided therein so as to enable one skilled in the art to practice the present invention. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

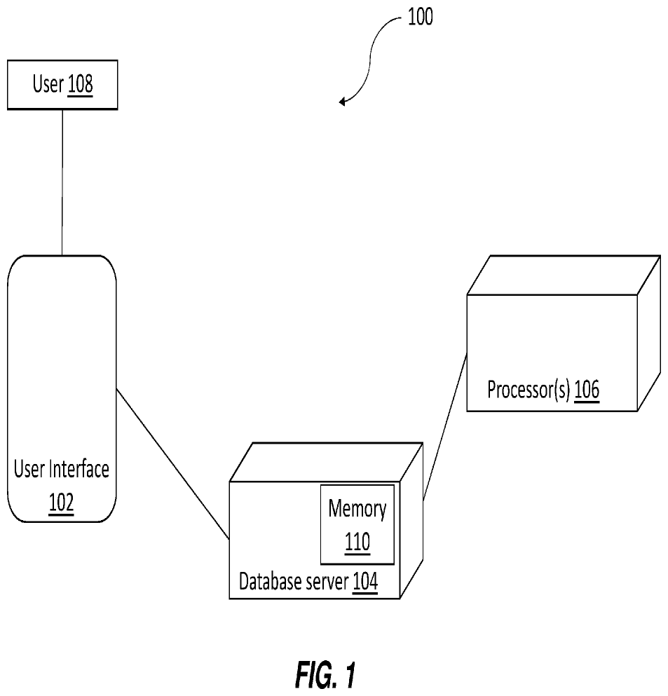

The present disclosure generally relates to a system and method for creating a customized commemorative event ticket. According to one configuration shown in FIG. 1, a user interface 102 is provided to allow a user 108 to interact with the system 100 to customize a commemorative ticket. According to another configuration, the user interface 102 may be provided just to allow the user to purchase a commemorative ticket that has been customized by the system 100. In some configurations, the user interface 102 may be provided on an application that is run on a user mobile device. In other configurations, the user interface 102 may be a website. In other configurations, the user interface 102 may be a kiosk, such as a kiosk provided at or near an event's venue, such as a kiosk at a stadium or concert hall. In some configurations, the user 108 may be the customer purchasing the commemorative ticket and in other configurations the user 108 interacting with the interface may be a worker or other person ordering the commemorative ticket on behalf of a customer. This may be the case at an event when, for example, a customer can order the commemorative ticket from a worker at a concession stand.

FIG. 1 depicts a system for ordering a customized commemorative event ticket or card. In this configuration, system 100 includes user interface 102, and a database server 104. The system may also optionally include a processor 106. While the database 104 and processor 106 as shown as being separate for clarity, it will be appreciated that they may be integral to the same hardware, for example, a server. User interface 102 may operate on a web server, application server, data server, a mobile device, or other computing device. Database 104 may be separate from the user interface 102 or the computer system on which the user interface executes. User interface 102 may be configured to accept connections via publicly available networks (e.g., the Internet), private networks and other dedicated or shared links, which may be wired or wireless. User interface 102 may communicate over the internet via such connections to the database server 104.

User interface 102 is configured to receive user connections, such as from user 108, and may operate differently (e.g., display different web pages, forms or menus) depending on a user's status. For example, for a connection from a new user, interface 102 may present the user with a registration form, information about services offered by the system, etc. For registered or other experienced users, interface 102 may present customized pages or displays. If the user interface 102 is located at a kiosk at a venue for a particular event, the interface may automatically bring up information (such as statistical data and photographs) related to the event taking place at that venue at that time.

Either a new user or a registered user may be prompted to scan a QR code from an event ticket, scan a bar code from an event ticket, or manually enter in data relating to an event. Once the QR code or bar code is scanned or the data entered manually, the user interface 102 may send the information to the database server 104 and/or processor 106, which may then retrieve the relevant information (as described in more detail below) and display the information on the user interface 102. (Or, for a user interface at a kiosk, the database server 104 may automatically retrieve the information based on the location of kiosk and time.)

The server database 104 may be connected via the internet to user interface 102, one or more databases containing information relating to the event, to the players who played at the event (such as for sporting events), to the performers who performed at the event, and/or a processor 106. One with skill in the art will appreciate that while the server database 104 is shown as a single structure, the server database need not be a single structure to accomplish the same task. For example, any structure, such as a discrete database and/or a discrete server may be used. The server database 104 may include a memory 110 to store information related to the unique QR code, unique bar code, and/or event entered. The server database 104 may be connected to a server and/or database (or formed integral to a server and/or database) and may continually check for updates to the information/data associated with the QR code, bar code, event data, etc. For example, the information for any given unique QR code or bar may include: location of the seats at the venue, game day purchase information, game day ticket seat information, photographs taken of the area near such seats, etc. Information for a QR code, bar code, or event-related data may include, for example: team and/or performer information, statistics relating to the game (for sporting events), statistics relating to players/performers, statistics relating to sports sabermetrics (for sporting events), pictures of player(s)/team(s)/performer(s)/attendees, etc.

The optional processor 106 may be a separate or specialized element of system 100 (e.g., a computer server) or may be incorporated into another element of the system (e.g., a data server, web server). The processor 106 may process data on the database server 104 and mark certain data as relevant to the user. The processor 106 may then communicate with the database to mark certain data as relevant to the user and display such data to the user 108 on the user interface 102.

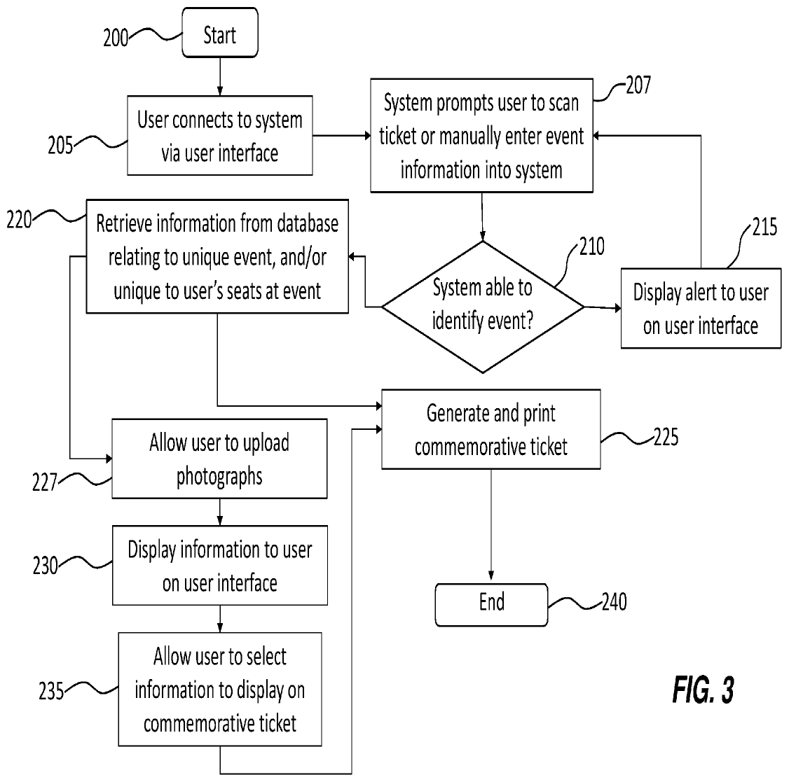

In one method of creating a customized commemorative event ticket according to system 100, a user 108 connects to system 100 and scans a QR code/bar code or manually inputs information relating to the relevant event. User interface 102, or the server operating the user interface, passes the information to the database server 104. Database server 104 then retrieves the data associated with the event, including any data related specifically to a unique QR code or barcode (which data has been optionally processed and flagged by processor 106). User 108 then obtains details of the data associated with the event through user interface 102 and provides the requested details. A more comprehensive method of the invention is described below in conjunction with FIG. 3. A user 108 may also obtain details of the data associated with the event through the user interface 102, and optionally select specific data to be included on a commemorative ticket. In other configurations, the system may automatically generate the commemorative ticket without the user 108 selecting any specific data.

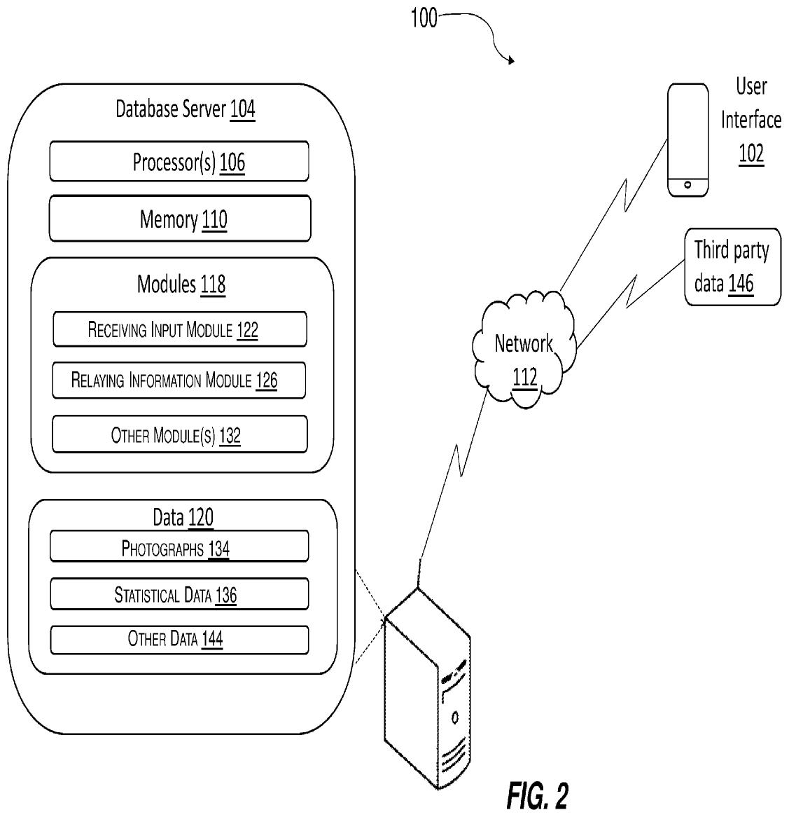

FIG. 2 shows a block diagram of another configuration of a system that may be used to generate a custom commemorative ticket. In this configuration, the database server 104 may comprise one or more processors 106, and a memory 110 configured to store data and information relating to a specific event. The memory 110 may also store information relating to a specific location at the specific event (such as photographs taken at or near specific seats at an event). For example, at a sporting event, photographs taken at the event from a specific section of the stadium and/or photographs taken of a specific section of the stadium may be stored by the memory 110 with the data associated with the sporting event and the location of the photograph.

In some configurations, when the user 108 either manually enters details about the event or scans a code, etc., the system may be configured to automatically display to the user 108 one or more photographs having data associated with the sporting event and the location of the photograph (either the location which the photograph was taken from, or the location displayed by the photograph). More specifically, the system may be configured to display to the user on the user interface 102 those photographs which have location data associated with the location of the customer's specific section and/or seating in the stadium. In some configurations, a user display may display only those photographs which have location data associated with the location of the customer's specific section and/or seating in the stadium. In other configurations, the user display may preferentially display those photos which have location data associated with the location of the customer's specific section and/or seating in the stadium.

The configuration in FIG. 2 may also comprise one or more modules 118, such as a receiving input module 122 programmed to receive input from a user interface. Such input may include a unique bar code or QR code from an event ticket, or input manually entered by a user on a user interface 102 relating to the event (such as date, time, venue, location of seats, etc.). A relaying information module 126 may also be provided, and may be programmed to relay information associated with the specific event (and/or specific location of seats at the event) back to the user interface 102. Other modules 132 may be provided as desired or necessary.

Data 120 may also be included in the database server 104, such as data relating to photographs 134 and statistical data 136. Other data 144 may be provided as desired or necessary. In addition to the data stored in memory 110, the system may also retrieve, via network 112, third party data 146 associated with specific event(s). Such third party data may also be used to generate the commemorative event ticket. Third party data may include photographs (including associated data with the photographs), statistical data, etc.

In use, a user 108 may first decide to order a commemorative ticket for an event. The event may be in the future or in the past. The following specific example will be given, by way of example, for a sporting event attended in the past. It will be appreciated that the event need not be a sporting event, and it also could be an event that has not yet occurred. Based on the time the commemorative ticket is ordered and the type of event, different options may be presented to the user via the user interface 102. Although the operations of the methods of FIG. 3 are shown and described in a particular order, the order of the operations of each method may be altered so that certain operations may be performed in an inverse order or so that certain operations may be performed, at least in part, concurrently with other operations.

For a sporting event that has already occurred, a user 108 may first select a user interface 102 to interact with. This may be a kiosk at the event's venue, an application on a mobile device, a website, etc. After a start 200 (FIG. 3), the user 108 connects to the system 100 via the user interface (205 in FIG. 3). User interface may then prompt the user 108 to enter details relating to the event, such as the date, location, specific seats, etc. (207 in FIG. 3). The user interface may also accomplish this data input by prompting the user 108 to scan a QR code or bar code associated with the user's ticket for the event. The scanning may be accomplished, for example, using the camera feature of a user's smartphone or a scanner located at a kiosk, etc.

After the data relating to the event and/or specific location of the seats at the event has been entered, the user interface 102 may communicate with a database to identify the event (210 in FIG. 3). If the system is not able to identify the event, it may display an alert to the user 108 on the user interface 102 (215 in FIG. 3) and re-prompt the user to scan their ticket or manually enter specific data related to the event. If the system is able to identify the event, the system may next communicate with one or more databases to retrieve information relating to the event (220 in FIG. 3). For a sporting event that has occurred, for example, the following are examples of data that may be retrieved: photographs of players who participated in the sporting event, photographs of teams who participated in the sporting event, photographs of players taken at or during the specific sporting event, photographs of the crowd taken at or during the sporting event, photographs of the crowd at or near the specific seats taken during the sporting event, location of the seats at the venue, game day purchase information, game day ticket seat information, team and/or player information, statistics relating to the game, statistics relating to players for the game, statistics relating to one player during the game, statistics relating to sports sabermetrics, etc. The photographs may also have specific location data associated therewith, such as a specific section of the stadium displayed in the photograph, specific seats of the stadium displayed in the photograph, and/or a specific section of the stadium from which the photograph was taken.

According to one configuration, the system 100 may retrieve information relating to the unique event, and then automatically generate and print a commemorative ticket 225. This may be delivered to the user directly (either via shipping to the user, or, if at a kiosk, by printing at the kiosk and making the commemorative ticket immediately or nearly immediately available).

According to another configuration, additional optional steps may be taken prior to generating and printing the commemorative ticket. Optionally, the user interface 102 may allow a user to upload their own photographs associated with the game, such as a user's photographs taken at the game (227 in FIG. 3). Another optional step shown in FIG. 2 may be to display the information retrieved by the system 100 to the user on the user interface (230 in FIG. 3). Another optional step shown in FIG. 2 may be to allow the user to select information to display on the commemorative ticket (235 in FIG. 3). This may allow a user to customize their commemorative ticket with information such as statistics relating to their favorite player for the game, their favorite photographs taken during the game (including photographs of the gameplay and/or photographs taken of themselves), etc. After the optional customizing steps 227, 230, 235 are completed, the system may then generate and print the commemorative ticket as described above (225 in FIG. 3). As part of the optional steps, the system in some configurations may selectively display to the user, on the user interface 102, photographs having data associated with the customer's specific location in the stadium for the event, such as a specific section of the stadium displayed in the photograph, specific seats of the stadium displayed in the photograph, and/or a specific section of the stadium from which the photograph was taken. For example, a system may automatically present/display to the user, via the user interface 102, only the photographs associated with the user's seat and/or section of the stadium. In some configurations, the system may present other photographs associated with the event, but may preferably display the photographs associated with the user's seat and/or section of the stadium, such as by displaying the photographs associated with the user's seat and/or section as larger than other photographs, or before the other photographs in a list or display of the photographs. Additionally, the photographs associated with the user's seat and/or section of the stadium may be updated on a third-party database in real-time as the event is proceeding.

In some configurations, the commemorative ticket may be generated for other types of activities, such as for one or more days spent at a destination (for example, Disneyland, SeaWorld, landmarks, other attractions, etc.). In other configurations, a user may utilize the systems and methods herein to create a commemorative ticket for an event which they did not attend in person (for example, an event watched on a personal computing device, a television, listed to on a radio, etc.). Commemorative tickets may also be desired for past games that a user either did or did not attend. These may include historical sporting events that are particularly special to the user (for example, the World Series game in the 1950s that their favorite baseball team won). Similarly, the commemorative ticket may be generated for a future game or event.

Herein is disclosed a computer-implemented method for creating a customized commemorative ticket for an event, the method comprising: retrieving, by a processor, one or more photographs taken at the event; retrieving, by the processor, one or more pieces of statistical data related to the event; generating, by a processor, a commemorative event ticket including the one or more photographs taken at the event and the one or more pieces of statistical data related to the event.

In some configurations, the method may further comprise the step of displaying, to a user on a user interface 102, the one or more photographs taken at the event and the one or more pieces of statistical data related to the event. In other configurations, the method may also comprise the step of allowing the user, via the user interface, to select one or more photographs taken at the event to be included on the commemorative ticket. In yet other configurations, the method may comprise the step of allowing the user, via the user interface, to select one or more pieces of statistical data related to the event to be included on the commemorative ticket. The method may also include the step of allowing the user, via the user interface, to upload one or more photographs associated with the event.

According to another aspect, a system is described for generating a customized commemorative ticket for an event, the system comprising: a user interface; a database server comprising a memory, the memory configured to store information relating to the event; the database server in communication with one or more processors and one or more user interfaces, the database server configured to accept an input from the one or more user interfaces and identify the event associated with the input, the database further configured to retrieve the information relating to the event from the memory, and communicate the information to the user interface in communication with the database server, and the database server further configured to generate a commemorative ticket for the event based on the information relating to the event.

According to one aspect, the information relating to the event comprises at least one of the following: one or more photographs taken at the event, one or more photographs of players who played at the event, one or more photographs of teams who played at the event, one or more pieces of statistical data related to the event, one or more pieces of statistical data related to a player who played at the event, one or more pieces of statistical data related to a team who played at the event, and one or more photographs of performers who performed at the event. In some configurations, the database is further configured to accept an input from the one or more user interfaces relating to photographs taken during the event.

According to another aspect, a method is described for creating a custom commemorative ticket for an event, the method comprising: receiving from a user, via a user interface in communication with a database, an input associated with the event; retrieving from the database the information associated with the event; sending to the user the information related to the event on the user interface; receiving from the user, via the user interface in communication with the database, the information desired to be included on the custom commemorative ticket; and generating, by the database, the custom commemorative ticket.

In some configurations, the step of retrieving from the database the information associated with the event comprises retrieving one or more photographs taken during the event. The step of receiving from the user, via the user interface in communication with the database, the input associated with the event, may comprise receiving a seat assignment of the user for the event. Where a seat assignment is received, the step of retrieving one or more photographs taken during the event may comprise retrieving photographs based on the seat assignment of the user.

According to one aspect, the information associated with the event comprise at least one of: team information, performer information, statistics relating to the event, statistics relating to players, statistics relating to performers, statistics relating to sports sabermetrics, pictures of a player, pictures of a performer, and pictures of a team.

The various embodiments described above, including elements of the various embodiments described above, can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

1. A computer-implemented method for creating a customized commemorative ticket for an event, the method comprising:
retrieving, by a processor, one or more photographs taken at the event;
retrieving, by the processor, one or more pieces of statistical data related to the event;
generating, by a processor, a commemorative event ticket including the one or more photographs taken at the event and the one or more pieces of statistical data related to the event.

2. The method of claim 1, further comprising the step of displaying, to a user on a user interface, the one or more photographs taken at the event and the one or more pieces of statistical data related to the event.

3. The method of claim 2, further comprising the step of allowing the user, via the user interface, to select one or more photographs taken at the event to be included on the commemorative ticket.

4. The method of claim 2, further comprising the step of allowing the user, via the user interface, to select one or more pieces of statistical data related to the event to be included on the commemorative ticket.

5. The method of claim 2, further comprising the step of allowing the user, via the user interface, to upload one or more photographs associated with the event.

6. A system for generating a customized commemorative ticket for an event, the system comprising:
a user interface;
a database server comprising a memory, the memory configured to store information relating to the event;
the database server in communication with one or more processors and one or more user interfaces,
the database server configured to accept an input from the one or more user interfaces and identify the event associated with the input,
the database further configured to retrieve the information relating to the event from the memory, and communicate the information to the user interface in communication with the database server, and
the database server further configured to generate a commemorative ticket for the event based on the information relating to the event.

7. The system of claim 6, wherein the information relating to the event comprises at least one of the following: one or more photographs taken at the event, one or more photographs of players who played at the event, one or more photographs of teams who played at the event, one or more pieces of statistical data related to the event, one or more pieces of statistical data related to a player who played at the event, one or more pieces of statistical data related to a team who played at the event, and one or more photographs of performers who performed at the event.

8. The system of claim 6, wherein the database is further configured to accept an input from the one or more user interfaces relating to photographs taken during the event.

9. A method for creating a custom commemorative ticket for an event, the method comprising:
receiving from a user, via a user interface in communication with a database, an input associated with the event;
retrieving from the database statistical data related to the event and photographs related to the event, the photographs comprising data related to the location displayed in the photograph;
sending to the user via the user interface the statistical data related to the event and the photographs related to the event;
receiving from the user, via the user interface in communication with the database, an instruction comprising desired information to be included on the custom commemorative ticket; and
generating, by the database, the custom commemorative ticket, including the desired information.

10. The method of claim 9, wherein the step of retrieving from the database the information associated with the event comprises retrieving one or more photographs taken during the event.

11. The method of claim 10, wherein the step of receiving from the user, via the user interface in communication with the database, the input associated with the event, comprises receiving a seat assignment of the user for the event.

12. The method according to claim 11, wherein the step of retrieving one or more photographs taken during the event comprises retrieving photographs based on the seat assignment of the user.

13. The method according to claim 9, wherein the information associated with the event comprise at least one of: team information, performer information, statistics relating to the event, statistics relating to players, statistics relating to performers, statistics relating to sports sabermetrics, pictures of a player, pictures of a performer, and pictures of a team.
